(19) United States
(12) Patent Application Publication
(10) Pub. No.: US 2012/0058399 A1
(43) Pub. Date: Mar. 8, 2012

(54) Branched polymer, method for making the same, and applications thereof

(75) Inventors: Kuo-Chung Cheng, Taipei City (TW); Chia-Chun Wang, Fengshan City (TW); Chiu-Ya Wang, Taipei City (TW); Wen-Wu Li, Taipei City (TW); Shao-Hsuan Lo, Taipei City (TW)

(73) Assignee: National Taipei University of Technology, Taipei City (TW)

(21) Appl. No.: 13/199,589

(22) Filed: Sep. 2, 2011

(30) Foreign Application Priority Data
Sep. 6, 2010 (TW) 099130034

(51) Int. Cl. H01M 10/056; C09K 3/18; C08G 65/26

(52) U.S. Cl. 429/314; 521/25; 252/70

(57) ABSTRACT

A branched polymer represented by formula (I):

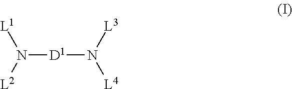

wherein at least one of L¹, L², L³, and L⁴ is a univalent organic group represented by formula (II):

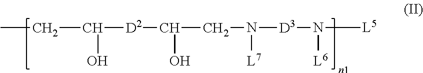

wherein L⁵, L⁶ and L⁷ are independently hydrogen or a univalent organic group, D¹, D² and D³ being independently a single bond or a divalent group, at least one of D¹, D², and D³ containing

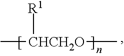

in which R¹ is hydrogen or a methyl group and n is an integer ranging from 1 to 1000; and the remainder of L¹, L², L³, and L⁴ being independently hydrogen or a univalent organic group represented by formula (III):

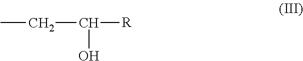

wherein R is a univalent end group, with the proviso that, when one of the remainder is hydrogen, the others of the remainder cannot be hydrogen.

### CROSS-REFERENCE TO RELATED APPLICATION

This application claims priority of Taiwanese application No. 099130034, filed on Sep. 6, 2010.

### BACKGROUND OF THE INVENTION

1. Field of the Invention

This invention relates to a branched polymer, a method for making the branched polymer, and a polymer electrolyte and a polymer electrolyte film that contain the branched polymer.

2. Description of the Related Art

In recent years, in order to accord with the demand for miniaturization of a battery device, solid polymer electrolytes (SPE) have been developed for use in a small scale battery device because of its adjustable volume. The solid polymer electrolyte is mainly made by mixing and reacting a polymer with a metal salt (such as a lithium salt). At present, polyethylene oxide (PEO), formed from open-ring polymerization by epoxy, is mostly used as the polymer for a solid polymer electrolyte. PEO is a linear polymer that has a helical structure, a low glass transition temperature, and high crystallization. When at a low temperature, the linear structure and the precipitation of PEO crystal may adversely influence the ion conduction of the solid polymer electrolyte made therefrom, thereby resulting in a relatively low conductivity of the final electrolyte product.

Therefore, it is desirable in the art to provide a polymer that has a branched structure and that may overcome the aforesaid drawbacks associated with the prior art.

### SUMMARY OF THE INVENTION

The object of the present invention is to provide a branched polymer, a method for making the same, and a polymer electrolyte and a polymer electrolyte film made therefrom.

According to one aspect of this invention, a branched polymer is represented by the following formula (I):

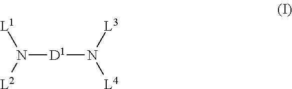

wherein at least one of L¹, L², L³, and L⁴ is a univalent organic group represented by the following formula (II):

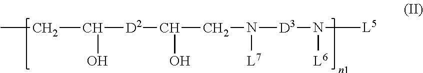

wherein D¹, D², and D³ are independently a single bond or a divalent group, at least one of D¹, D², and D³ containing

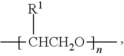

in which R¹ is hydrogen or a methyl group and n is an integer ranging from 1 to 1000,

n1 being an integer ranging from 1 to 1000,

L⁵ being hydrogen or a univalent organic group represented by the following formula (III):

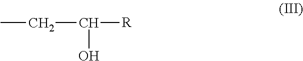

wherein R is a univalent end group that optionally contains

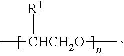

in which R¹ is hydrogen or a methyl group and n is an integer ranging from 1 to 1000,

L⁶ and L⁷ being independently hydrogen, a univalent organic group of formula (III), or a univalent organic group represented by the following formula (IV):

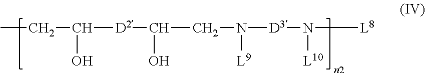

wherein D^{2′} and D^{3′} respectively have the same definitions as D² and D³,

L⁸, L⁹, and L¹⁰ respectively having the same definitions as L⁵,

n2 being an integer ranging from 1 to 1000; and

the remainder of L¹, L², L³, and L⁴ being independently hydrogen or a univalent organic group represented by formula (III),

with the proviso that, when one of the remainder is hydrogen, the others of the remainder cannot be hydrogen.

According to a second aspect of this invention, a method for making the aforesaid branched polymer comprises: reacting a polyamino compound represented by H₂N-D⁴-NH—Y¹ with an epoxy component that includes a diepoxy compound represented by

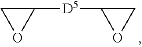

wherein D⁴ is a single bond or a divalent group and D⁵ is a divalent group, at least one of D⁴ and D⁵ containing

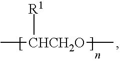

in which R¹ is hydrogen or a methyl group and n is an integer ranging from 1 to 1000,

Y¹ being hydrogen or a univalent end group optionally containing

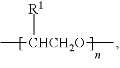

in which R¹ is hydrogen or a methyl group and n is an integer ranging from 1 to 1000.

According to a third aspect of this invention, a polymer electrolyte comprises the aforesaid branched polymer and a salt.

According to a fourth aspect of this invention, a polymer electrolyte film comprises the aforesaid polymer electrolyte.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 shows FT-IR spectrums for Example 1 of the branched polymer and Example 8 of the polymer electrolyte of this invention;

FIG. 2 shows FT-IR spectrums for Example 2 of the branched polymer and Example 9 of the polymer electrolyte of this invention;

FIG. 3 shows FT-IR spectrums for Example 3 of the branched polymer and Example 10 of the polymer electrolyte of this invention;

FIG. 4 shows FT-IR spectrums for Example 4 of the branched polymer and Example 11 of the polymer electrolyte of this invention;

FIG. 5 shows FT-IR spectrums for Example 5 of the branched polymer and Example 12 of the polymer electrolyte of this invention;

FIG. 6 shows FT-IR spectrums for Example 6 of the branched polymer and Examples 13 to 16 of the polymer electrolytes of this invention;

FIG. 7 is a ¹³C-NMR spectrum for Example 2 of the branched polymer of this invention;

FIG. 8 is a ¹³C-NMR spectrum for Example 2 of the branched polymer of this invention;

FIG. 9 is a ¹³C-NMR spectrum for Example 3 of the branched polymer of this invention;

FIG. 10 is a ¹³C-NMR spectrum for Example 4 of the branched polymer of this invention;

FIG. 11 is a ¹³C-NMR spectrum for Example 5 of the branched polymer of this invention;

FIG. 12 is a ¹³C-NMR spectrum for Example 6 of the branched polymer of this invention;

FIG. 13 is a scanning electron microscope image showing the morphology of a porous polymer film (M_{T}-40) before immersing in a polymer electrolyte of this invention; and

FIG. 14 is a scanning electron microscope image showing the morphology of the porous polymer film (M_{T}-40) after immersing in the polymer electrolyte of this invention.

### DETAILED DESCRIPTION OF THE PREFERRED EMBODIMENTS

The preferred embodiment of a branched polymer according to this invention is represented by the following formula (I):

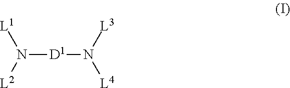

wherein at least one of L¹, L², L³, and L⁴ is a univalent organic group represented by the following formula (II):

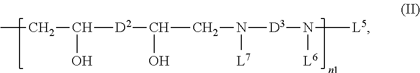

and

the remainder of L¹, L², L³, and L⁴ being independently hydrogen or a univalent organic group represented by the following formula (III):

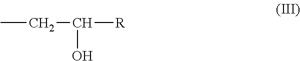

wherein R is a univalent end group that optionally contains

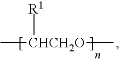

in which R¹ is hydrogen or a methyl group and n is an integer ranging from 1 to 1000,

with the proviso that, when one of the remainder is hydrogen, the others of the remainder cannot be hydrogen.

Preferably, at least three of L¹, L², L³, and L⁴ are univalent organic groups represented by formula (II).

In formula (II), D¹, D², and D³ are independently a single bond or a divalent group. At least one of D¹, D², and D³ contains

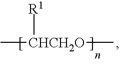

in which R¹ is hydrogen or a methyl group and n is an integer ranging from 1 to 1000.

Preferably, D¹, D², and D³ are independently —X¹-G-X²—,

wherein G is a single bond or

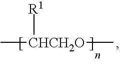

in which R¹ is hydrogen or a methyl group and n is an integer ranging from 1 to 1000, and

X¹ and X² being independently selected from the group consisting of a single bond, a C₁ to C₄₀ alkylene group, a C₂ to C₄₀ alkenylene group, a C₃ to C₂₀ cycloalkylene group, a C₆ to C₁₀ arylene group, a divalent heterocyclic group, a silanylene group, a siloxanylene group,

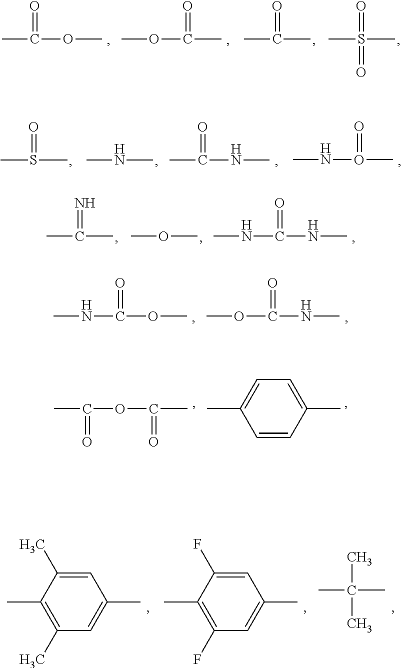

and combinations thereof,

wherein the C₁ to C₄₀ alkylene group, C₂ to C₄₀ alkenylene group, C₃ to C₂₀ cycloalkylene group, C₆ to C₁₀ arylene group, divalent heterocyclic group, silanylene group, and siloxanylene group are optionally substituted with fluorine or a cyano group.

More preferably, D¹ and D³ are the same and are selected from the group consisting of

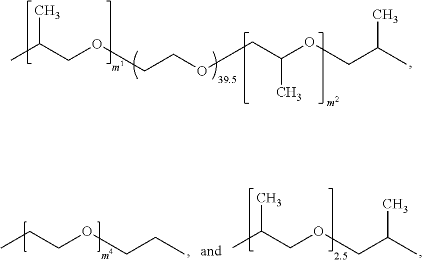

wherein m¹+m²=5 and m⁴=1−300; and D² is

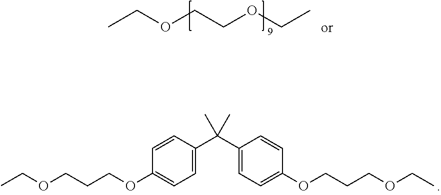

In the examples of this invention, D¹ and D³ are the same and are

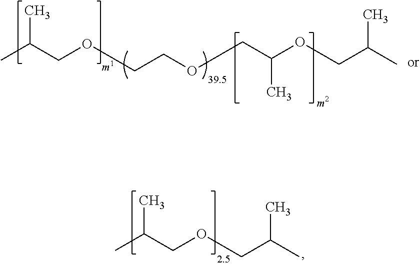

### and D² is

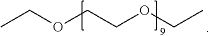

In formula (II), n1 is an integer ranging from 1 to 1000; L⁵ is hydrogen or a univalent organic group of formula (III); L⁶ and L⁷ are independently hydrogen, a univalent organic group of formula (III), or a univalent organic group represented by the following formula (IV):

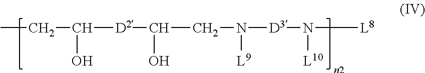

wherein D^{2′} and D^{3′} respectively have the same definitions as D² and D³ of formula (II),

L⁸, L⁹, and L¹⁰ respectively having the same definitions as L⁵ of formula (II), and

n2 being an integer ranging from 1 to 1000.

Preferably, in formula (III), R is selected from the group consisting of a C₁ to C₄₀ alkyl group, a C₂ to C₄₀ alkenyl group, a C₁ to C₄₀ alkoxy group, a C₃ to C₂₀ cycloalkyl group, a C₆ to C₁₀ aryl group, a heterocyclic group, an amino group, an imine group, a silanyl group, a siloxanyl group, an amido group, an imido group, an ester group, a ketone group, a urea group, an aminoformate group, an anhydride group, a sulfonyl group, a sulfoxide group, an ether group, a formyl group, and combinations thereof, wherein the C₁ to C₄₀ alkyl group, C₂ to C₄₀ alkenyl group, C₃ to C₂₀ cycloalkyl group, C₆ to C₁₀ aryl group, heterocyclic group, silanyl group, and siloxanyl group are optionally substituted with fluorine or a cyano group.

In the examples of this invention, R is

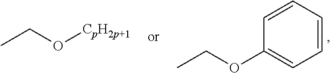

wherein p is 4 or an integer ranging from 12 to 14.

Preferably, the branched polymer of this invention has a weight average molecule weight ranging from 1000 to 100000, more preferably, from 4000 to 9000.

Preferably, the branched polymer of this invention has a polydispersity index (PDI) ranging from 1 to 2.

The preferred embodiment of a method for making the aforesaid branched polymer comprises: reacting a polyamino compound represented by H₂N-D⁴-NH—Y¹ with an epoxy component that includes a diepoxy compound represented by

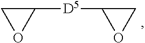

wherein D⁴ and D⁵ are independently a single bond or a divalent group, at least one of D⁴ and D⁵ containing

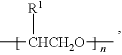

in which R¹ is hydrogen or a methyl group and n is an integer ranging from 1 to 1000,

Y¹ being hydrogen or a univalent end group optionally containing

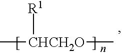

in which R¹ is hydrogen or a methyl group and n is an integer ranging from 1 to 1000.

Preferably, Y¹ has the same definition as R of formula (III), and D⁴ and D⁵ respectively have the same definitions as D¹ and D² of formula (I) and formula (II).

More preferably, the polyamino compound is selected from, but is not limited to, the group consisting of polyoxyethylene/oxypropylene diamine (PEDA, e.g.,

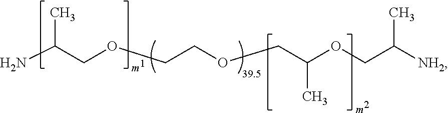

wherein m¹+m²=5), polyoxyethylene diamine (e.g.,

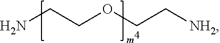

wherein m⁴=1−300), and polyoxypropylene diamine (e.g.,

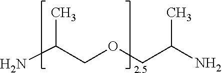

). In the examples of this invention, the polyamino compound is PEDA or polyoxypropylene diamine.

More preferably, the diepoxy compound is selected from, but is not limited to, the group consisting of

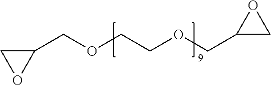

(poly(ethylene glycol) diglycidyl ether, PEGDE),

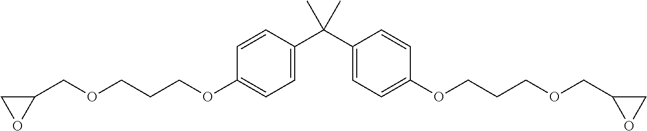

(bisphenol A propoxylate diglycidyl ether),

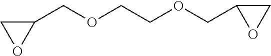

(ethylene glycol diglycidyl ether),

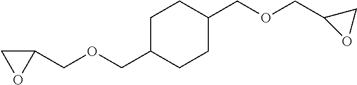

(1,4-cyclohexanedimethanol diglycidyl ether),

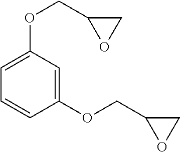

(resorcinol diglycidyl ether), and

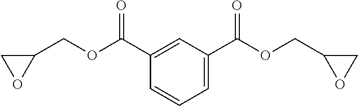

(2,3-diepoxypropyl phthalate). In the examples of this invention, the diepoxy compound is PEGDE.

Preferably, the epoxy component used in the method for making the aforesaid branched polymer further includes a monoepoxy compound represented by

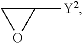

wherein Y² is hydrogen or a univalent end group that optionally contains

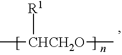

in which R¹ is hydrogen or a methyl group and n is an integer ranging from 1 to 1000.

Preferably, Y² has the same definition as R of formula (III). More preferably, the monoepoxy compound is selected from, but is not limited to, the group consisting of

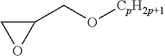

(named butyl glycidyl ether (BGE) when p=4, and dodecyl/tetradecyl glycidyl ether (AGE) when p=12-14,

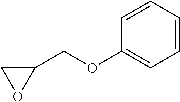

(phenyl glycidyl ether, PGE), 2-ethylhexyl glycidyl ether, and tert-butyl phenyl glycidyl ether.

It should be noted that the epoxy component may optionally include the monoepoxy compound, and the mole ratio of the polyamino compound, the diepoxy compound, and the monoepoxy compound is adjustable based on actual requirements. Preferably, themole ratioofthepolyamino compound, the diepoxy compound, and the monoepoxy compound ranges from 1:0.1:0.1 to 1:2:4. In the examples of this invention, the mole ratio is 1:0.75:2.5.

A preferred embodiment of a polymer electrolyte of the present invention comprises the aforesaid branched polymer and a salt. The polymer electrolyte may be produced by mixing and reacting the branched polymer with the salt. Alternatively, the polymer electrolyte may be produced by reacting the polyamino compound, the epoxy component, and the salt at the same time.

Preferably, the salt is a salt of lithium or a salt of iodine, such as, but not limited to, LiClO₄, LiCF₃SO₃, LiN(CF₃SO₂)₂, LiI, LiBF₄, LiPF₆, KI, NaI, N[(CH₂)₃CH₃]₄I, etc. In the examples of this invention, the salt is LiClO₄, and the mole ratio of the oxygen in the branched polymer to the lithium in the salt of lithium is 15:1.

The aforesaid polymer electrolyte may be used for preparing a battery or an anti-freezing agent.

Because the branched polymer of this invention includes high electronegative atoms that have unpaired electrons (e.g., O and N), a cation dissociated from the salt easily attach to and form a temporary coordination bond with the branched polymer through the electronegative atoms. Accordingly the branched polymer and the salt may coordinate to form a stable electrolyte system. Moreover, since the branched polymer of this invention has a low glass transition temperature and amorphicity that are advantageous to the cations moving in the branched polymers, the polymer electrolyte of this invention has superior conductivity.

The present invention also discloses a polymer electrolyte film including the aforesaid polymer electrolyte. The polymer electrolyte film may be produced by mixing the polymer electrolyte with a solvent to obtain an electrolyte solution, followed by contacting a polymer film with the electrolyte solution, e.g., coating the electrolyte solution on the polymer film, or immersing the polymer film in the electrolyte solution. Preferably, the solvent is alcohol and the polymer film is an epoxy resin film.

Alternatively, the polymer electrolyte film may be produced by mixing the polymer electrolyte with a solvent to obtain an electrolyte solution, followed by mixing the electrolyte solution with an epoxy resin and a curing agent, and thermal curing the mixture. Preferably, the curing agent is present in an amount of 10 parts by weight based on 100 parts by weight of the epoxy resin. Preferably, in the mixture, the weight ratio of the polymer electrolyte to the epoxy resin and the curing agent ranges from 80:20 to 45:55. Preferably, the thermal curing is conducted under a temperature ranging from 40° C. to 70° C. .

### EXAMPLE

### Sources of Chemicals

1. Poly(ethylene glycol)diglycidyl ether (PEGDE): commercially available from Aldrich, with a molecular weight of 526 g/mol.

2. Phenyl glycidyl ether (PGE): commercially available from Acros, with a molecular weight of 150.18 g/mol.

3. Butyl glycidyl ether (BGE): commercially available from Aldrich, with a molecular weight of 130 g/mol.

4. Dodecyl and tetradecyl glycidyl ether (AGE): commercially available from Aldrich, with a molecular weight of 300 g/mol.

5. Fluorene glycidyl ether (FGE): commercially available from JSI, with a molecular weight of 288 g/mole.

6. Polyoxypropylene diamine: commercially available from Huntsman under a trade name of D-230, with a molecular weight of 230 g/mol.

7. Polyoxyethylene/oxypropylene diamine (PEDA): commercially available from Aldrich, with a molecular weight of 2000 g/mol.

8. LiClO₄: commercially available from Aldrich.

9. Tetrahydrofuran (THF): commercially available from Aldrich.

10. Bisphenol A type epoxy: commercially available from Dow Chemical Company under a trade name of D.E.R. 231.

11. Tri(dimethylaminomethyl)phenol: commercially available from Aldrich under a trade name of DMP30.

### Equipments

1. Gel permeation chromatography (GPC): commercially available from Waters under a trade name of 510 HPLC Pump; equipped with a detector under a trade name of RI 2000 and chromatography columns under trade names of PL gel 3 μm 100 Å 300×7.5 mm, PL gel 5 μm MIXED-C 300×7.5 mm, and PL gel 5 μm 50×7.5 mm. Polystyrene was used as a standard.

2. Fourier transformation infrared (FT-IR) spectrometer: commercially available from Perkin Elmer under a trade name of Spectrum 2000.

3. NMR spectrometer: commercially available from Bruker under a trade name of Avance-400 MHz FT NMR. 4.

4. Differential scanning calorimeter (DSC): commercially available from TA Instrument under a trade name of DSC2920.

5. Thermogravimetric analyzer (TGA): commercially available from TA Instrument under a trade name of Q50.

6. Electrochemical analyzer: commercially available from CH Instruments under a trade name of CHI614B.

### Examples 1 to 7

### Preparation of Branched Polymer

Predetermined amounts of a polyamino compound, a diepoxy compound (i.e., PEGDE), and a monoepoxy compound were uniformly mixed in a mole ratio of 1:0.75:2.5, followed by heating the mixture to conduct the polymerization reaction. Branched polymers of Examples 1 to 7 were obtained. In the examples of this invention, there were two stages for the polymerization reaction, in which the reaction times for the first and second stages were respectively 2 hours and 10 hours.

The species of the polyamino compound, the monoepoxy compound, and the reaction temperature for the polymerization reactions for each of Examples 1 to 7 are shown in Table 1.

### Measurement of Mₙ, M_{w} and PDI

1 gram of the branched polymer prepared from each of Examples 1 to 7 was dissolved in 100 grams of THF. The weight average molecular weight (M_{w}), number average molecular weight (Mₙ), and polydispersity index (PDI) of the branched polymers were measured using GPC. The conversion rate for each of the polymerization reaction for Examples 1 to 7 was measured and calculated by titration. The measurement results are shown in Table 2.

### Structure Identification

1 gram of the branched polymer prepared from each of Examples 1 to 6 was dissolved in 100 grams of THF so as to obtain a branched polymer solution, followed by spreading the branched polymer solution on a KBr salt plate. The structures of the branched polymers were identified using FT-IR and ¹³C-NMR spectra.

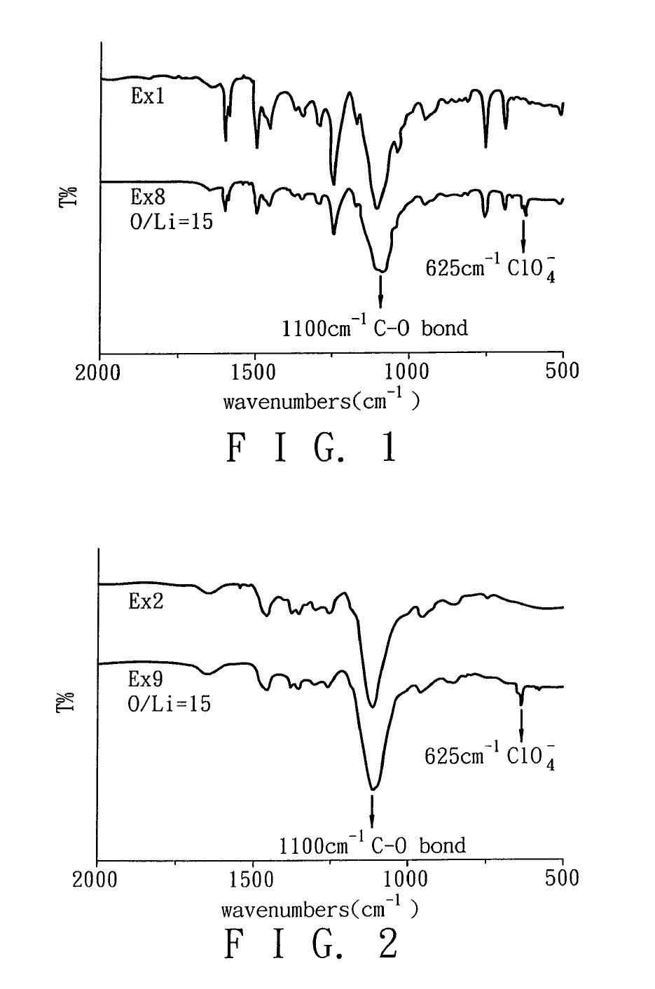

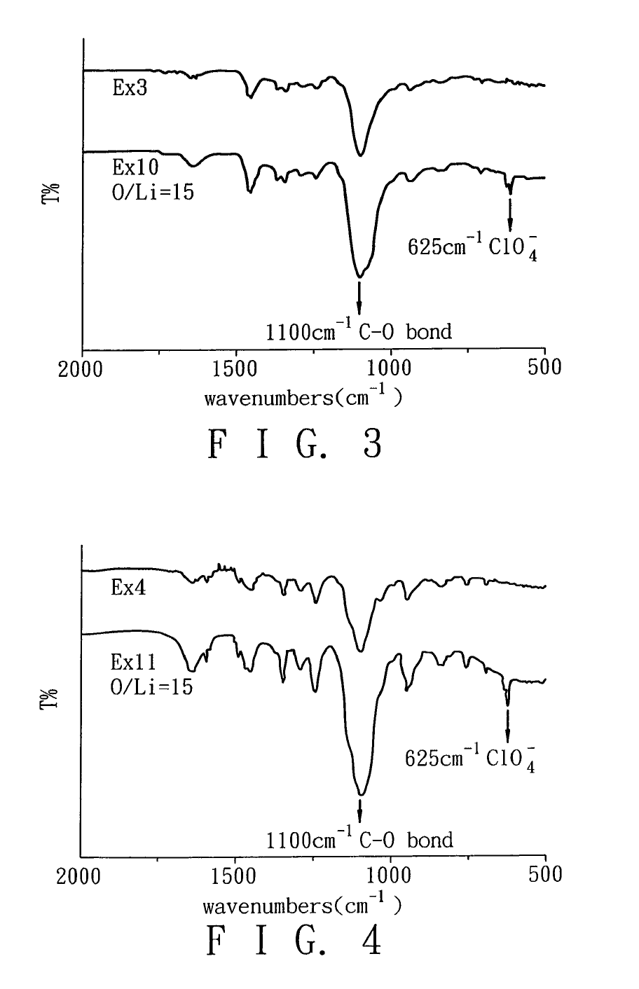

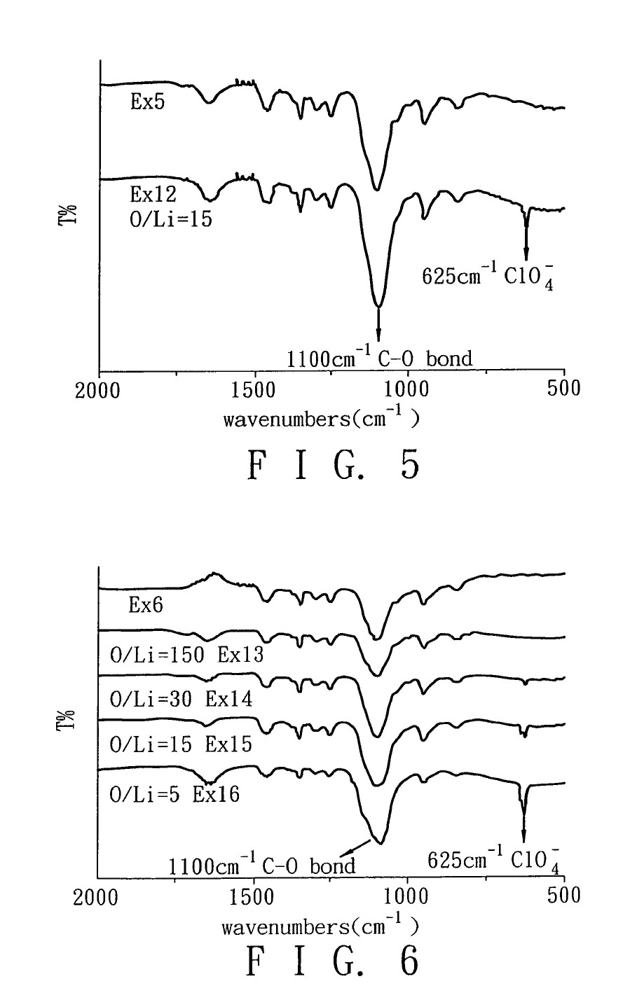

Referring to FIGS. 1 to 6, the FT-IR results show that, in the spectra of the branched polymers of Example 1 to 6, no intensity was detected at the epoxy group absorbance peak, i.e., 912 cm⁻¹, while O—H absorbance peak was observed at 950 cm⁻¹. The FT-IR data verify the production and existence of the branched polymers.

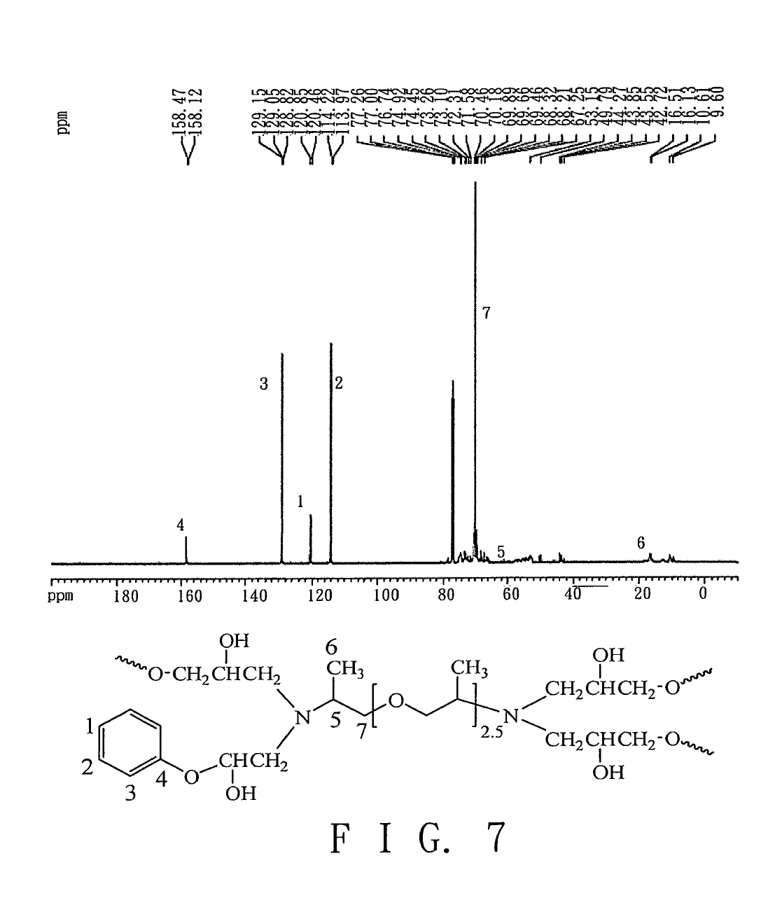

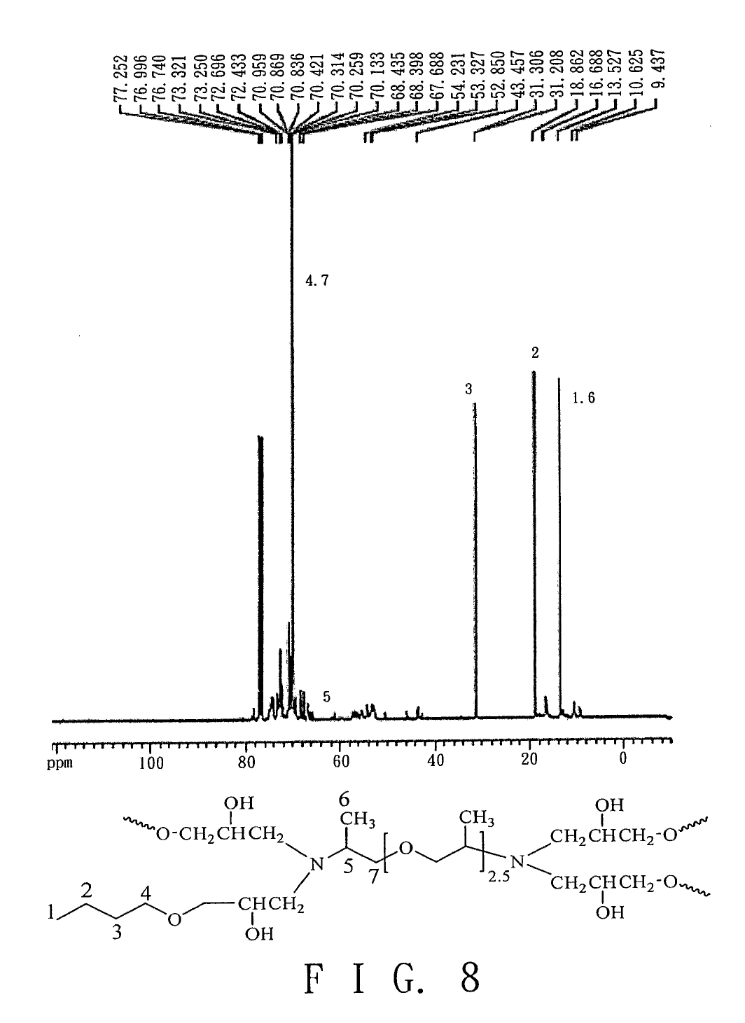

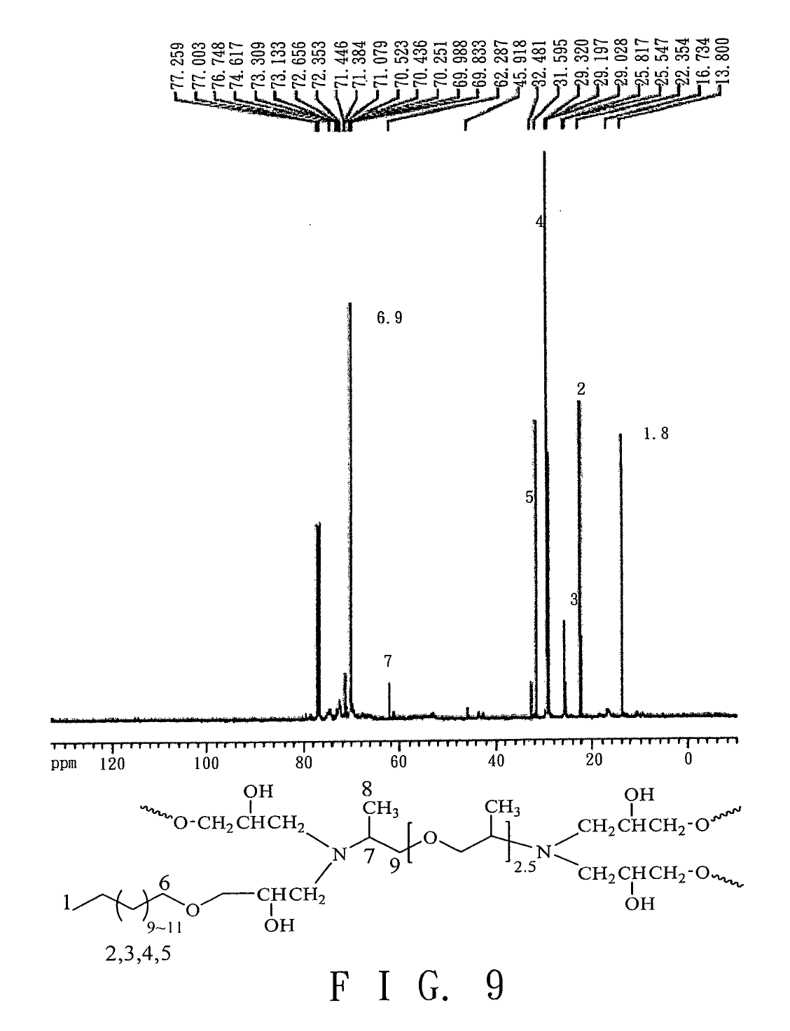

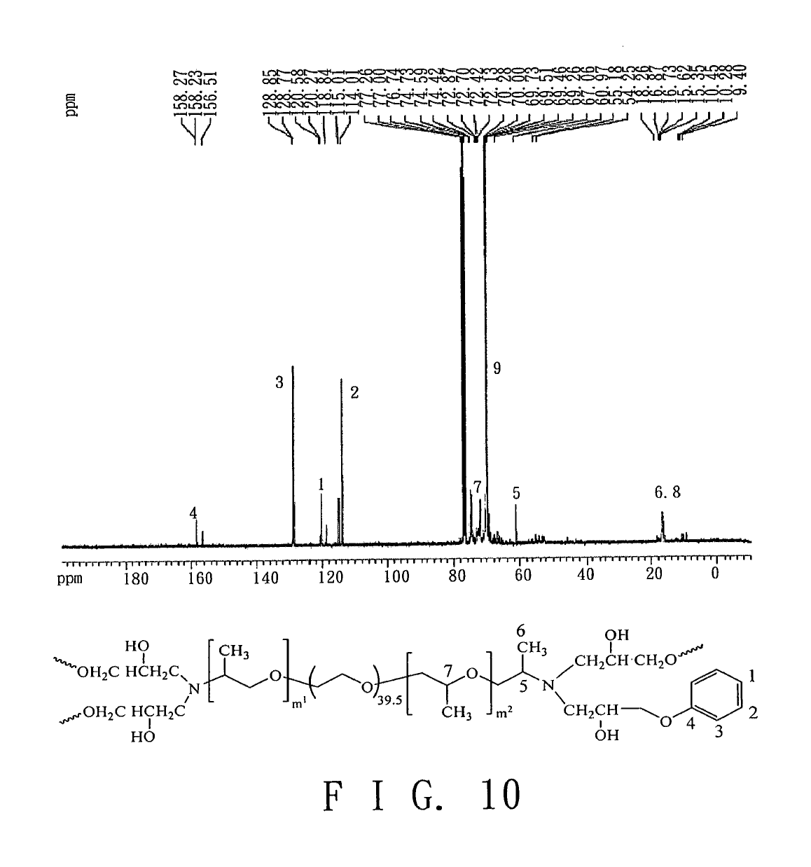

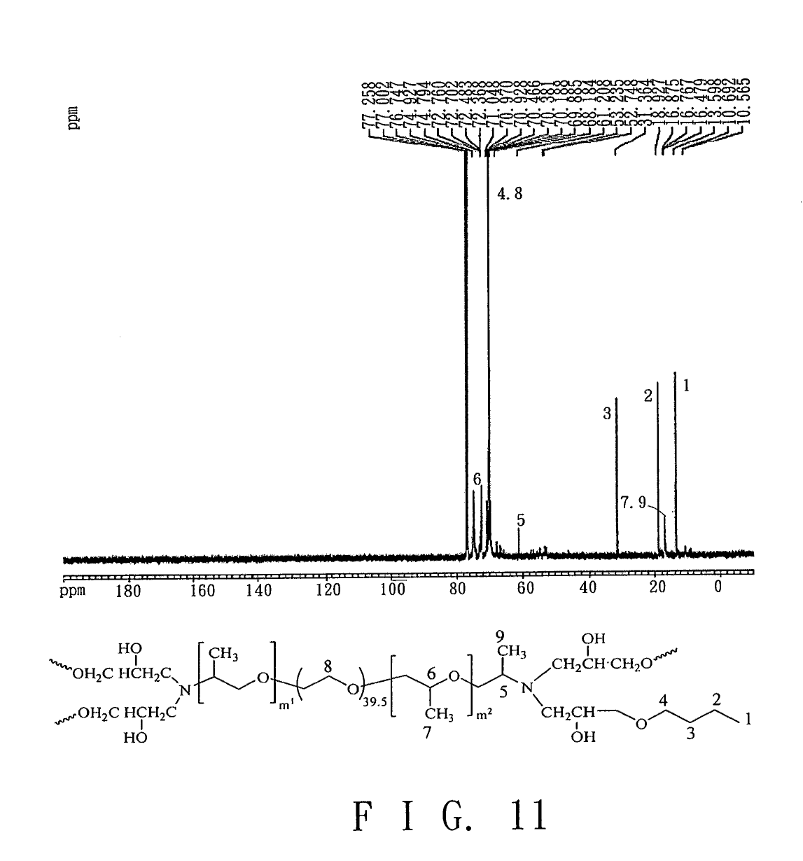

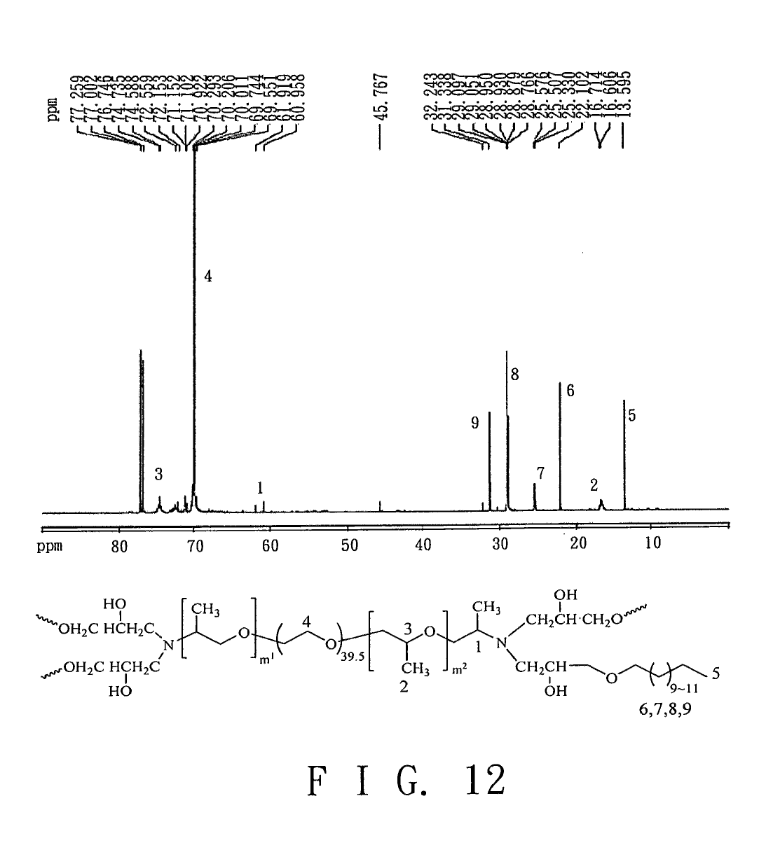

As shown in FIGS. 7 to 12, ¹³C-NMR spectra of Examples 1 to 6 also indicate the existence of the branched polymers of this invention, which are consistent with the FT-IR results.

TABLE 1

| | | | Polymerization Reaction | |
|---|---|---|---|---|
| | | | 1^{st} Stage | 2^{nd} Stage |
| Example | Polyamino | Monoepoxy | Temperature | Temperature |
| (Ex) | Compound | Compound | (° C.) | (° C.) |
| 1 | D-230 | PGE | 90 | 150 |
| 2 | | BGE | 110 | 170 |
| 3 | | AGE | 130 | 195 |
| 4 | PEDA | PGE | 130 | 200 |
| 5 | | BGE | 155 | 200 |
| 6 | | AGE | 155 | 200 |
| 7 | | FGE | 133 | 206 |

TABLE 2

| | M_{w} | Mₙ | Polydispersity | Conversion |
|---|---|---|---|---|
| Example | (g/mol) | (g/mol) | Index (PDI) | Rate (%) |
| 1 | 5224 | 2937 | 1.8 | 82.6 |
| 2 | 4508 | 2680 | 1.7 | 81.0 |
| 3 | 5637 | 3838 | 1.5 | 80.4 |
| 4 | 7268 | 6115 | 1.2 | 84.3 |
| 5 | 7787 | 6024 | 1.3 | 83.3 |
| 6 | 8406 | 6823 | 1.2 | 84.6 |
| 7 | 5070 | 2797 | 1.8 | 83.0 |

### Examples 8 to 16

### Preparation of Polymer Electrolyte

Predetermined amount of each of the branched polymers prepared from Examples 1 to 7 was mixed with predetermined amount of LiClO₄, followed by adding dehydrated THF to form a reaction solution. The reaction solution was uniformly mixed in an ultrasonic oscillator for 30minutes, followed by disposing the reaction solution in a vacuum oven at 65° C. for 24 hours to remove THF and to obtain the polymer electrolytes of Examples 8 to 17.

The branched polymer used for preparation of the aforesaid polymer electrolyte and the mole ratio of oxygen to lithium (O/Li ratio) for each of Examples 8 to 17 are shown in Table 3.

TABLE 3

| Example | Branched Polymer Resource | O/Li Ratio |
|---|---|---|
| 8 | Example 1 | 15 |
| 9 | Example 2 | |
| 10 | Example 3 | |
| 11 | Example 4 | |
| 12 | Example 5 | |
| 13 | Example 6 | 150 |
| 14 | | 30 |
| 15 | | 15 |
| 16 | | 5 |
| 17 | Example 7 | 15 |

Examples 8 to 17 were dried in a vacuum oven at 90° C. for 24 hours before the following analyses in order to prevent moisture from interfering with the test results.

### Structure Identification

The structure of the polymer electrolytes of Examples 8 to 16 were identified using FT-IR spectra.

Referring to FIGS. 1 to 6, the FT-IR results of Examples 8 to 16 show similar curve profiles as those of Examples 1 to 7, except that the ClO₄⁻ absorbance peak was observed at 625 cm⁻¹. The FT-IR data verify the appearance and existence of the polymer electrolytes of this invention.

### Thermogravimetric Analysis

The temperatures at the 5% weight loss (T_{5 wt % loss}) and at the maximum decomposition rate (T_{d}) for each of Examples 1 to 17 were measured by heating 10 to 15 micrograms of Examples 1 to 17 from room temperature to 600° C. at a heating rate of 20° C. /min using a thermogravimetric analyzer (TGA), in which the flow rate for nitrogen was 90 L/min. The results for T_{5 wt % loss} and T_{d} are shown in Table 4.

The maximum degraded temperatures for Examples 1-6 and 8-16 are all higher than 250° C., which indicate great heat stabilities thereof.

### Measurement of Glass Transition Temperature (T_{g})

5 to 10 micrograms of each of Examples 1 to 17 were pressed to form a tablet. The glass transit ion temperature (T_{g}) for each of the tablets was determined using a differential scanning calorimetry (DSC). A heating chamber of the DSC device was quenched with liquid nitrogen to −100° C. and subsequently heated to a temperature of 100° C. at a heating rate of 10° C./min. The measurement results are shown in Table 4.

### Measurement of Ion Conductivity (σ)

The ion conductivity of each of Examples 1 to 17 was measured by an AC impedance method (applied voltage: 20 mV; frequency: 1 Hz to 100 kHz using an electrochemical analyzer. The measurement was conducted and recorded at temperatures of 20° C., 30° C., 40° C., 50° C., 60° C., and 70° C., and the results are shown in Table 5. Higher ion conductivity is preferred.

TABLE 4

| | Example | T_{5 wt % loss} (° C.) | T_{d} (° C.) | T_{g} (° C.) |
|---|---|---|---|---|
| Branched | 1 | 305 | 348 | −17.2 |
| Polymer | 2 | 295 | 365 | −45.5 |
| | 3 | 272 | 368 | −41.2 |
| | 4 | 323 | 405 | −37.4 |
| | 5 | 324 | 399 | −52.3 |
| | 6 | 304 | 401 | −44.5 |
| | 7 | 86 | 400 | −60 |
| Polymer | 8 | 280 | 366 | 6.2 |
| Electrolyte | 9 | 272 | 377 | −26.8 |
| | 10 | 247 | 374 | −24.7 |
| | 11 | 282 | 369 | −31.5 |
| | 12 | 271 | 384 | −39.4 |
| | 13 | 285 | 397 | −43.6 |
| | 14 | 267 | 398 | −37.3 |
| | 15 | 268 | 389 | −39.5 |
| | 16 | 259 | 376 | −21.0 |
| | 17 | — | — | −60 |

TABLE 5

| | Ion Conductivity (σ, S/cm) | | | | | |
|---|---|---|---|---|---|---|
| Example | 20° C. | 30° C. | 40° C. | 50° C. | 60° C. | 70° C. |
| 1 | <1.00 × 10⁻⁸ | <1.00 × 10⁻⁸ | 2.79 × 10⁻⁸ | 6.98 × 10⁻⁸ | 1.66 × 10⁻⁷ | 3.55 × 10⁻⁷ |
| 2 | <1.00 × 10⁻⁸ | 2.56 × 10⁻⁸ | 5.64 × 10⁻⁸ | 1.15 × 10⁻⁷ | 2.11 × 10⁻⁷ | 3.67 × 10⁻⁷ |
| 3 | 3.96 × 10⁻⁸ | 1.02 × 10⁻⁷ | 1.89 × 10⁻⁷ | 3.36 × 10⁻⁷ | 5.64 × 10⁻⁷ | 8.81 × 10⁻⁷ |
| 4 | 6.01 × 10⁻⁸ | 1.20 × 10⁻⁷ | 2.15 × 10⁻⁷ | 3.64 × 10⁻⁷ | 5.58 × 10⁻⁷ | 7.70 × 10⁻⁷ |
| 5 | 4.96 × 10⁻⁸ | 1.07 × 10⁻⁷ | 1.55 × 10⁻⁷ | 4.61 × 10⁻⁷ | 7.01 × 10⁻⁷ | 9.84 × 10⁻⁷ |
| 6 | 2.10 × 10⁻⁸ | 3.85 × 10⁻⁸ | 6.60 × 10⁻⁸ | 1.06 × 10⁻⁷ | 1.60 × 10⁻⁷ | 2.48 × 10⁻⁷ |
| 7 | 2.98 × 10⁻⁶ | 2.17 × 10⁻⁶ | 1.47 × 10⁻⁶ | 8.97 × 10⁻⁷ | 5.51 × 10⁻⁷ | 3 × 10⁻⁷ |
| 8 | <1.00 × 10⁻⁸ | <1.00 × 10⁻⁸ | 1.16 × 10⁻⁶ | 1.56 × 10⁻⁶ | 5.38 × 10⁻⁶ | 8.20 × 10⁻⁶ |
| 9 | 1.27 × 10⁻⁸ | 4.38 × 10⁻⁶ | 1.18 × 10⁻⁵ | 2.83 × 10⁻⁵ | 5.88 × 10⁻⁵ | 1.10 × 10⁻⁴ |
| 10 | 3.76 × 10⁻⁷ | 1.00 × 10⁻⁶ | 2.67 × 10⁻⁶ | 6.19 × 10⁻⁶ | 1.31 × 10⁻⁵ | 2.49 × 10⁻⁵ |
| 11 | 2.85 × 10⁻⁶ | 9.50 × 10⁻⁶ | 2.59 × 10⁻⁵ | 6.00 × 10⁻⁵ | 1.26 × 10⁻⁴ | 2.3 × 10⁻⁴ |
| 12 | 1.35 × 10⁻⁵ | 3.64 × 10⁻⁵ | 8.91 × 10⁻⁵ | 1.83 × 10⁻⁴ | 3.38 × 10⁻⁴ | 5.64 × 10⁻⁴ |
| 13 | 3.57 × 10⁻⁶ | 1.50 × 10⁻⁵ | 2.56 × 10⁻⁵ | 3.97 × 10⁻⁵ | 5.67 × 10⁻⁵ | 8.15 × 10⁻⁵ |
| 14 | 9.80 × 10⁻⁶ | 2.05 × 10⁻⁵ | 3.45 × 10⁻⁵ | 5.08 × 10⁻⁵ | 6.28 × 10⁻⁵ | 1.17 × 10⁻⁴ |
| 15 | 2.10 × 10⁻⁵ | 5.08 × 10⁻⁵ | 1.07 × 10⁻⁴ | 2.03 × 10⁻⁴ | 3.48 × 10⁻⁴ | 5.31 × 10⁻⁴ |
| 16 | 1.06 × 10⁻⁶ | 4.36 × 10⁻⁶ | 1.42 × 10⁻⁵ | 4.10 × 10⁻⁵ | 9.88 × 10⁻⁵ | 2.14 × 10⁻⁴ |
| 17 | 6.07 × 10⁻⁴ | 3.60 × 10⁻⁴ | 2.07 × 10⁻⁴ | 1.09 × 10⁻⁴ | 5.23 × 10⁻⁵ | 2.29 × 10⁻⁵ |

The ion conductivities of Examples 8 to 17 are higher than those of Examples 1 to 7, which indicate that the addition of LiClO₄ improves the ion conductivities of the branched polymers of this invention. In the group of Examples 1 to 7 and the group of Examples 8 to 17, Example 7 and Example 17, which contain fluorine glycidyl ether (FGE), respectively have superior ion conductivity than other examples.

In addition, comparing the measurement results of ion conductivity with those of glass transition temperature in Table 3, it is shown that, in the group of Examples 1 to 7 and the group of Examples 8 to 17, the ion conductivity increases as the glass transition temperature decreases. The tendency indicates that the ion conductivity is influenced by the polymer structure and the polydispersity index (PDI) of the branched polymer.

### Example 18

### Preparation of Polymer Electrolyte Film

0.685 gram of the polymer electrolyte prepared from Example 12 was dissolved in an alcohol solution (concentration: 99.9 vol %) and mixed in an ultrasonic oscillator for 30 minutes for complete dissolution of the polymer electrolyte in the alcohol solution so as to obtain a polymer electrolyte solution. A porous polymer film, M_{T}-40, was immersed in the polymer electrolyte solution and oscillated in an ultrasonic oscillator for 2 hours such that the porous polymer film absorbed the polymer electrolyte solution to form a polymer electrolyte film. The polymer electrolyte film was dried in a vacuum oven at 100° C. for removing alcohol and was subsequently weighed. A first absorbance of the polymer electrolyte film was measured using the following equation:

Absorbance (wt %)=weight after absorption (g)−weight before absorption (g)/weight before absorption (g)×100%.

After repeating the above steps of immersing the polymer film in the polymer electrolyte solution and drying the same, a second absorbance of the polymer electrolyte film was measured. The first and second absorbances for the polymer electrolyte film of Example 18 were respectively 76 wt % and 78 wt %. The difference between the first and second absorbances is small that indicates the absorptibn of the polymer electrolyte film was substantially saturated at the first time of absorption. The final polymer electrolyte film of Example 18 was obtained after drying in a vacuum oven at 100° C. for 24 hours.

### Examples 19 to 24

### Preparation of Polymer Electrolyte Film

0.8566 gram of the polymer electrolyte prepared from Example 12 was dissolved in an alcohol solution (concentration: 99.9 vol %) and mixed in an ultrasonic oscillator for 30 minutes for complete dissolution of the polymer electrolyte in the alcohol solution so as to obtain a polymer electrolyte solution. Bisphenol A type epoxy and tri(dimethylaminomethyl)phenol (serving as a curing agent) were mixed at a weight ratio of 10:1 to form a reactant mixture.

Each of the polymer electrolyte solutions was mixed with the reactant mixture to form a precursor mixture.

The precursor mixture was poured into a mold and was cured in a hot-air oven at 40° C. for 48 hours, followed by disposing in a vacuum atmosphere at 70° C. for 24 hours to remove alcohol. Subsequently, the precursor mixture was dried in a vacuum oven at 100° C. to obtain the polymer electrolyte film for each of Examples 19 to 24. In the precursor mixture, the respective amounts of the polymer electrolyte and the reactant mixture for each of Examples 19 to 24 are shown in Table 6.

TABLE 6

| | Amount of Polymer | Amount of Reactant |
|---|---|---|
| Example | Electrolyte (wt %) | Mixture (wt %) |
| 19 | 80 | 20 |
| 20 | 70 | 30 |
| 21 | 60 | 40 |
| 22 | 55 | 45 |
| 23 | 50 | 50 |
| 24 | 45 | 55 |

### Measurements of T_{g} and Ion Conductivity

The glass transition temperature (T_{g}) and ion conductivity for each of Examples 18 to 24 were measured using the same method as described above. The measurement results are shown in Table 7.

TABLE 7

| | T_{g} | Ion Conductivity (σ, S/cm) | | | | | |
|---|---|---|---|---|---|---|---|
| Example | (° C.) | 20° C. | 30° C. | 40° C. | 50° C. | 60° C. | 70° C. |
| 12 | −39 | 1.35 × 10⁻⁵ | 3.64 × 10⁻⁵ | 8.91 × 10⁻⁵ | 1.83 × 10⁻⁴ | 3.38 × 10⁻⁴ | 5.64 × 10⁻⁴ |
| M_{T}-40 | 104 | — | | | | | |
| 18 | −41 | 1.02 × 10⁻⁵ | 2.58 × 10⁻⁵ | 4.55 × 10⁻⁵ | 6.98 × 10⁻⁵ | 1.03 × 10⁻⁴ | 1.39 × 10⁻⁴ |
| | 107 | | | | | | |
| 19 | −25.6 | 2.88 × 10⁻⁶ | 5.56 × 10⁻⁶ | 1.56 × 10⁻⁶ | 3.53 × 10⁻⁵ | 7.27 × 10⁻⁵ | 1.44 × 10⁻⁴ |
| 20 | −16.1 | 1.77 × 10⁻⁷ | 2.43 × 10⁻⁷ | 6.83 × 10⁻⁷ | 1.89 × 10⁻⁶ | 7.18 × 10⁻⁶ | 1.76 × 10⁻⁵ |
| 21 | −4.0 | 2.66 × 10⁻⁸ | 8.88 × 10⁻⁸ | 2.90 × 10⁻⁷ | 7.36 × 10⁻⁷ | 1.73 × 10⁻⁶ | 3.09 × 10⁻⁶ |
| 22 | 3.5 | <1.00 × 10⁻⁸ | 2.85 × 10⁻⁸ | 1.01 × 10⁻⁷ | 2.42 × 10⁻⁷ | 8.71 × 10⁻⁷ | 1.40 × 10⁻⁶ |
| 23 | 5.0 | <1.00 × 10⁻⁸ | 3.98 × 10⁻⁹ | 1.27 × 10⁻⁸ | 2.55 × 10⁻⁸ | 1.44 × 10⁻⁷ | 3.27 × 10⁻⁷ |
| 24 | 6.1 | <1.00 × 10⁻⁸ | <1.00 × 10⁻⁸ | 9.77 × 10⁻⁹ | 2.28 × 10⁻⁸ | 5.09 × 10⁻⁸ | 1.08 × 10⁻⁷ |

The two glass transition temperatures of the polymer electrolyte film prepared from Example 18 indicates that the polymer electrolyte film includes a polymer electrolyte and a polymer film. The measurement results of T_{g} for Examples 19 to 24 show that T_{g} is increased with a decrease in the amount of the polymer electrolyte.

The ion conductivity of Example 18 is higher than those of Examples 19 to 24, which indicates that a polymer electrolyte film made from Example 18 has superior properties.

### Observation of Morphology

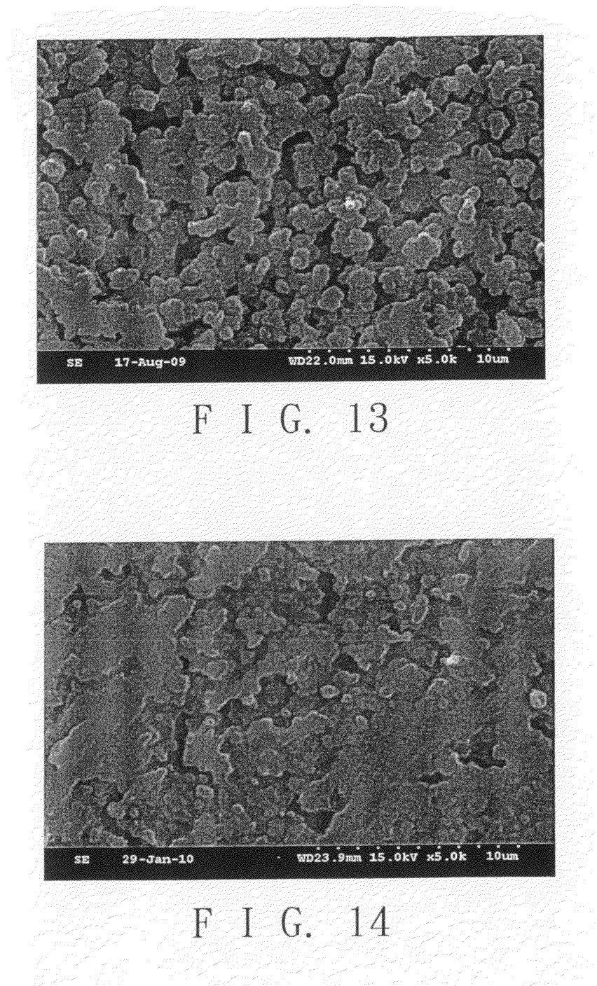

The morphology of the porous polymer film, i.e., M_{T}-40, used in Example 18 and the morphology of the final polymer eletrolyte film of Example 18 were observed using a scanning electron microscope. The morphology observations are shown in FIGS. 13 and 14, which show that the porous polymer film is filled with the polymer electrolyte after immersing in the polymer electrolyte solution.

In conclusion, the branched polymers of the present invention have the properties of great thermal stability, low glass transition temperature, and amorphicity, and thus can be used as a conductive material. Moreover, the method for making the branched polymer of this invention is simple and convenient. The polymer electrolyte made from the branched polymer exhibits superior heat stability, and the polymer electrolyte film made from the aforesaid polymer electrolyte has good conductivity.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

What is claimed is:

1. A branched polymer represented by the following formula (I): 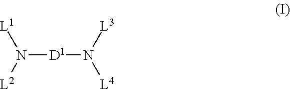
wherein at least one of L¹, L², L³, and L⁴ is a univalent organic group represented by the following formula (II): 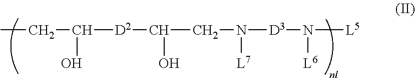
wherein D¹, D² and D³ are independently a single bond or a divalent group, at least one of D¹, D², and D³ containing 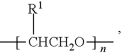
in which R¹ is hydrogen or a methyl group and n is an integer ranging from 1 to 1000,
n1 being an integer ranging from 1 to 1000,
L⁵ being hydrogen or a univalent organic group represented by the following formula (III): 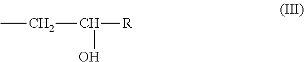
wherein R is a univalent end group that optionally contains 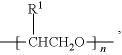
in which R¹ is hydrogen or a methyl group and n is an integer ranging from 1 to 1000,
L⁶ and L⁷ being independently hydrogen, a univalent organic group of formula (III), or a univalent organic group represented by the following formula (IV): 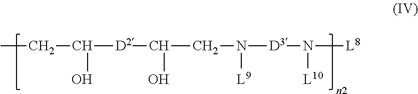
wherein D^{2′} and D^{3′} respectively have the same definitions as D² and D³,
L⁸, L⁹, and L¹⁰ respectively having the same definitions as L⁵,
n2 being an integer ranging from 1 to 1000;
the remainder of L¹, L², L³, and L⁴ being independently hydrogen or a univalent organic group represented by formula (III),
with the proviso that, when one of said remainder is hydrogen, the others of said remainder cannot be hydrogen.

2. The branched polymer of claim 1, wherein at least three of L¹, L², L³, and L⁴ are univalent organic groups represented by formula (II).

3. The branched polymer of claim 1, wherein D¹, D², and D³ are independently —X¹-G-X²—,
wherein G is a single bond or 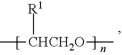
in which R¹ is hydrogen or a methyl group and n is an integer ranging from 1 to 1000, and
X¹ and X² are independently selected from the group consisting of a single bond, a C₁ to C₄₀ alkylene group, a C₂ to C₄₀ alkenylene group, a C₃ to C₂₀ cycloalkylene group, a C₆ to C₁₀ arylene group, a divalent heterocyclic group, a silanylene group, a siloxanylene group, 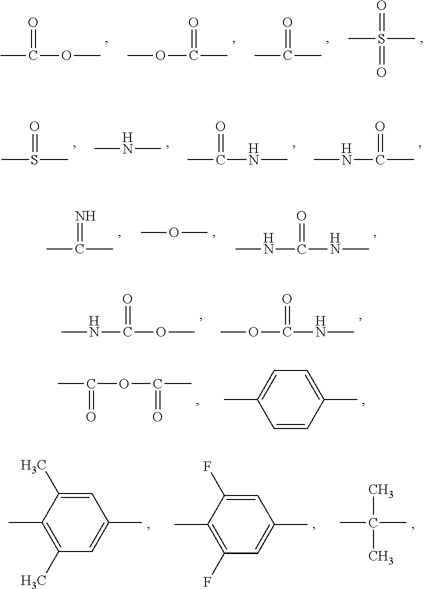
and combinations thereof,
wherein said C₁ to C₄₀ alkylene group, C₂ to C₄₀ alkenylene group, C₃ to C₂₀ cycloalkylene group, C₆ to C₁₀ arylene group, divalent heterocyclic group, silanylene group, and siloxanylene group are optionally substituted with fluorine or a cyano group.

4. The branched polymer of claim 1, wherein R of formula (III) is selected from the group consisting of a C₁ to C₄₀ alkyl group, a C₂ to C₄₀ alkenyl group, a C₁ to C₄₀ alkoxy group, a C₃ to C₂₀ cycloalkyl group, a C₆ to C₁₀ aryl group, a heterocyclic group, an amino group, an imine group, a silanyl group, a siloxanyl group, an amido group, an imido group, an ester group, a ketone group, an urea group, an aminoformate group, an anhydride group, a sulfonyl group, a sulfoxide group, an ether group, a formyl group, and combinations thereof,
wherein said C₁ to C₄₀ alkyl group, C₂ to C₄₀ alkenyl group, C₃ to C₂₀ cycloalkyl group, C₆ to C₁₀ aryl group, heterocyclic group, silanyl group, and siloxanyl group are optionally substituted with fluorine or a cyano group.

5. The branched polymer of claim 1, wherein said branched polymer has a weight average molecule weight ranging from 1000 to 100000.

6. A method for making a branched polymer as claimed in claim 1, comprising:
reacting a polyamino compound represented by H₂N-D⁴-NH—Y¹ with an epoxy component that includes a diepoxy compound represented by 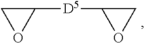
wherein D⁴ and D⁵ are independently a single bond or a divalent group, at least one of D⁴ and D⁵ containing 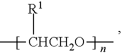
in which R¹ is hydrogen or a methyl group and n is an integer ranging from 1 to 1000,
Y¹ being hydrogen or a univalent end group optionally containing 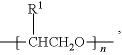
in which R¹ is hydrogen or a methyl group and n is an integer ranging from 1 to 1000.

7. The method of claim 6, wherein Y¹ has the same definition as R in claim 4.

8. The method of claim 6, wherein D⁴ and D⁵ respectively have the same definitions as D¹ and D² in claim 3.

9. The method of claim 8, wherein the polyamino compound is polyoxyethylene/oxypropylene diamine, polyoxyethylene diamine, or polyoxypropylene diamine.

10. The method of claim 8, wherein the diepoxy compound is poly(ethylene glycol) diglycidyl ether, or bisphenol A propoxylate diglycidyl ether.

11. The method of claim 6, wherein the epoxy component further includes a monoepoxy compound represented by 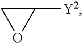
wherein Y² is hydrogen or a univalent end group that optionally contains 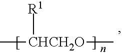
in which R¹ is hydrogen or a methyl group and n is an integer ranging from 1 to 1000.

12. The method of claim 11, wherein Y² has the same definition as R in claim 4.

13. The method of claim 12, wherein the monoepoxy compound is dodecyl/tetradecyl glycidyl ether, butyl glycidyl ether, or phenyl glycidyl ether.

14. A polymer electrolyte, comprising a branched polymer as claimed in claim 1, and a salt.

15. The polymer electrolyte of claim 14, wherein the salt includes a salt of lithium or a salt of iodine.

16. The polymer electrolyte of claim 15, wherein said salt is selected from the group consisting of LiClO₄, LiCF₃SO₃, LiN (CF₃SO₂)₂, LiI, LiBF₄, LiPF₆, KI, NaI, and N[(CH₂)₃CH₃]₄I.

17. A polymer electrolyte film, comprising a polymer electrolyte as claimed in claim 14.
